(19) United States
(12) Patent Application Publication
(10) Pub. No.: US 2007/0019350 A1
(43) Pub. Date: Jan. 25, 2007

(54) Short circuit protection for complementary circuit

(75) Inventor: Don Blackwell, San Jose, CA (US)

Correspondence Address: Fountainhead Law Group;Ste. 509, 900 Lafayette St., Santa Clara, CA, 95050, US

(73) Assignee: Power Analog Microelectronics, Inc., Santa Clara, CA (US)

(21) Appl. No.: 11/166,435

(22) Filed: Jun. 24, 2005

(51) Int. Cl. H02H 3/08

(52) U.S. Cl. 361/93.1

(57) ABSTRACT

Embodiments of the present invention include short circuit protection techniques. In one embodiment, the present invention includes a short circuit protection circuit wherein circuit an output terminal of an electronic circuit is compared against another node in the circuit that should have a complementary signal during normal operation. If the signals are not complementary, then a disable signal may be generated and the electronic circuit may be turned off.

### BACKGROUND

The present invention relates to electronic circuits, and in particular, to short circuit protection for electronic circuits.

FIG. 1 illustrates the problem addressed by the present invention. Electronic circuits, such as circuit 101 illustrated in FIG. 1, typically have at least one input terminal for receiving input signals and at least one output terminal that includes output signals. Electronic circuits typically require a power supply to operate properly. For example, some circuits may operate on a positive power supply (e.g., +5 volts) and a negative power supply (e.g., −5 volts) and other circuits may operate on a single supply (e.g., + or −5 volts) and ground (e.g., zero volts). When the output of an electronic circuit is intentionally or unintentionally connected to one of its operating supplies or ground, large amounts of current may be produced by the output. This is referred to as a “short circuit.” Many circuits are not designed to be connected to the operational supplies or ground. Thus, when such a connection occurs, the large currents generated can cause damage to the circuit. It is generally desirable to include “short circuit protection” circuits in electronic circuits so that when short circuits occur, the electronic circuit is not damaged.

FIG. 1 is an example of a complementary circuit. In a complementary circuit, the electronics coupled to the first and second output terminals are complementary to one another. For example, if circuit 101 is an analog complementary circuit, out+ may be a continuous signal having a peak-to-peak amplitude in the range of +/−200 mV. The complementary output, out−, will be a substantially similar signal that is out of phase from out+ by 180 degrees. Thus, if out+ is a sinusoid having an amplitude 100 mV and a maximum value at t=t1, then the complementary terminal out− will have a sinusoidal signal with an amplitude of 100 mV with a minimum value at t=t1 (in this case, the signals are both complementary and symmetric). In a digital system, a complementary circuit may include digital signals on one terminal and the inverse of the signal on the other terminal. One problem with complementary circuits is that the outputs may be damaged if they are shorted together. Damage may result because complementary outputs will typically try to drive their outputs in opposite directions. Thus, when the outputs are shorted together, large currents may be generated that may damage internal devices.

Thus, there is a need for improved short circuit protection. The present invention solves these and other problems by providing to short circuit protection circuits and methods.

### SUMMARY

Embodiments of the present invention include short circuit protection techniques. In one embodiment, the present invention includes a short circuit protection circuit comprising a first circuit having a first output terminal, a second complementary output terminal, an enable input terminal, and at least one node, wherein a first voltage on the first output terminal has a complementary phase relationship to a second voltage on the at least one node under normal operation, and a short circuit protection circuit having a first input terminal coupled to the first output terminal of the first circuit, a second input terminal coupled to the at least one node of the first circuit, and an output terminal coupled to the enable input terminal of the first circuit, wherein if the first output terminal is electrically connected to the second output terminal, the short circuit protection circuit generates a disable signal to the enable input terminal turning off the first circuit.

In one embodiment, the at least one node is connected to the second output terminal.

In one embodiment, the at least one node is a node internal to the first circuit.

In one embodiment, the short circuit protection circuit comprises a comparison circuit and a processing circuit that processes the output of the comparison circuit and generates said disable signal.

In one embodiment, the comparison circuit comprises an exclusive OR circuit.

In one embodiment, the processing circuit comprises an RC circuit and an inverter.

In one embodiment, the short circuit protection circuit comprises a window comparator circuit having a first input coupled to the first output terminal and an exclusive OR circuit having a first input coupled to an output of the window comparator circuit and a second input coupled to the at least one node.

In one embodiment, the short circuit protection circuit includes a timing circuit, wherein if a short circuit is detected the timing circuit turns off the first circuit for a first time period.

In one embodiment, the present invention includes a short circuit protection circuit comprising a first circuit having a first output terminal, a second complementary output terminal, an enable input terminal, and at least one node, wherein a first voltage on the first output terminal has a complementary phase relationship to a second voltage on the at least one node under normal operation, and a short circuit protection circuit including a comparison circuit having a first input coupled to the first output terminal of the first circuit, a second input terminal coupled to the at least one node of the first circuit, a timing circuit having an input coupled to an output of the comparison circuit and an output coupled to the enable input terminal of the first circuit, wherein if the first output terminal is electrically connected to the second output terminal, the short circuit protection circuit generates a disable signal to the enable input terminal turning off the first circuit for at least a first time period determined by the timing circuit.

In one embodiment, the comparison circuit comprises an exclusive OR gate.

In one embodiment, the comparison circuit comprises a window comparator coupled to an exclusive OR gate.

In one embodiment, the comparison circuit comprises a NAND gate.

In one embodiment, the timing circuit comprises a resistor and capacitor.

In one embodiment, the timing circuit comprises a counter and a latch.

In one embodiment, the present invention includes a short circuit protection method comprising comparing a first voltage on a first output terminal of a first circuit to a second voltage on at least one other node in the circuit having a complementary voltage during normal operation, and generating at least one disable signal when the first voltage is not complementary to the second voltage, and in accordance therewith, turning off the first circuit.

In one embodiment, the method further comprises resetting the disable signal after a first time period.

In one embodiment, the at least one node is connected to the second output terminal.

In one embodiment, the at least one node is a node internal to the first circuit.

In one embodiment, the method further comprises storing a voltage on a capacitor and resetting the disable signal when the voltage on the capacitor discharges through a resistor.

The following detailed description and accompanying drawings provide a better understanding of the nature and advantages of the present invention.

### BRIEF DESCRIPTION OF THE DRAWINGS

FIG. 1 illustrates a short circuit in a complementary electronic circuit.

FIG. 2A illustrates a short circuit protection circuit according to one embodiment of the present invention.

FIG. 2B illustrates a short circuit protection circuit according to one embodiment of the present invention.

FIG. 3 is an example of a short circuit protection circuit according to another embodiment of the present invention.

FIG. 4 is an example of a short circuit protection circuit according to another embodiment of the present invention.

FIG. 5 is another example of a short circuit protection circuit according to one embodiment of the present invention.

FIGS. 6A and 6B illustrate another example of a short circuit protection circuit according to one embodiment of the present invention.

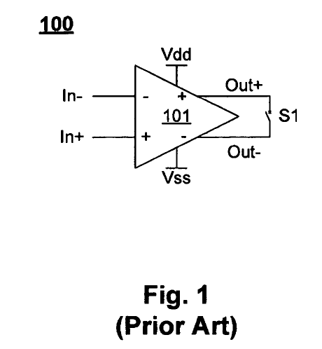

### DETAILED DESCRIPTION

Described herein are techniques for improving short circuit protection. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

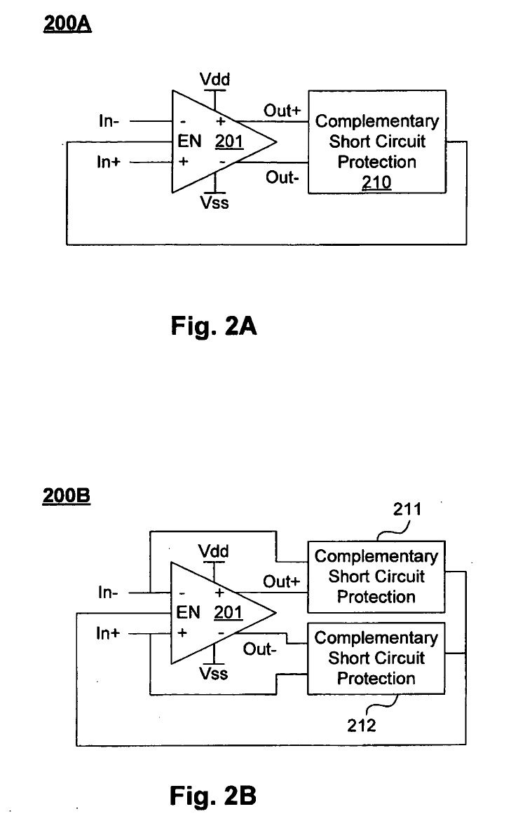

FIG. 2A illustrates a short circuit protection circuit according to one embodiment of the present invention. Circuit 200A includes a complementary electronic circuit 201 and a complementary short circuit protection circuit 210. Electronic circuit 201 may be any circuit that has complementary first and second output terminals (e.g., out+ and out−). In this example, electronic circuit 201 also includes complementary first and second input terminals (e.g., in+ and in−) for receiving complementary input signals. However, it is to be understood that circuit 201 may have only a single input terminal, and may include internal circuitry for generating complementary output signals. Electronic circuit 201 also includes an enable input terminal (EN). The enable input may be used to turn some or all of the circuit on or off. When an enable signal (e.g., a high or low logic signal) is received by the enable input terminal, the circuit will be enabled and operate normally. When a disable signal (e.g., a low or high logic level) is received by the enable input terminal, the circuit will be turned off. In one embodiment, only the circuitry driving the output terminals may be turned off when a disable signal is received at the enable input. In other embodiments, the circuitry driving the output terminals and additional circuitry are turned off when a disable signal is received at the enable input. It is to be understood that the disable and enable signals may be any of a variety of signals (analog or digital) for triggering the turning on and turning off of some or all of electronic circuit 201. Complementary short circuit protection circuit 210 includes a first input terminal coupled to the first output terminal of electronic circuit 201, a second input terminal coupled to the second output terminal of electronic circuit 201, and an output terminal coupled to the enable input of electronic circuit 201. If the first output terminal of electronic circuit 201 is electrically connected to the second output terminal, the complementary short circuit protection circuit generates a disable signal to the enable input terminal turning off the circuit.

FIG. 2B illustrates a short circuit protection circuit according to one embodiment of the present invention. Circuit 200B includes a complementary electronic circuit 201 having a first input terminal “in−”, a second input terminal “in+”, a first output terminal “out+”, and a second output terminal “out−”. In this embodiment, a complementary short circuit protection circuit 211 has a first input coupled to the first output terminal “out+” of circuit 201 and a second input coupled to the first input “in−” of circuit 201. As shown in FIG. 2B, the first input of the circuit “in−” is complementary to the first output terminal “out+” during normal operation. Similarly, a second complementary short circuit protection circuit 212 has a first input coupled to the second output terminal “out−” of circuit 201 and a second input coupled to the second input “in+” of circuit 201. As shown in FIG. 2B, the second input of the circuit “in+” is complementary to the second output terminal “out−” during normal operation. Protection circuits 211 and 212 will generate disable signals when the voltage between each respective input and output is not complementary. Each protection circuit has an output coupled to the enable input terminal of circuit 201. Thus, if either circuit generates a disable signal, circuit 201 will be turned off.

While the protection circuits in the above embodiments are illustrated as being coupled between outputs or an input and complementary output, it is to be understood that the inputs of the protection circuit could be coupled between other complementary nodes. Typically, one input to the protection circuit will be coupled to an output terminal that is connected to an external pin of a device so that if a short occurs as a result of a circuit being handled by a person, the protection circuit will protect the device from being destroyed. However, the other input may be connected either to a complementary output terminal, to a complementary input terminal, or to a complementary internal node. Typically, one protection circuit input will be connected to a complementary node in the signal path to the output terminal to which the other input of the protection circuit is connected.

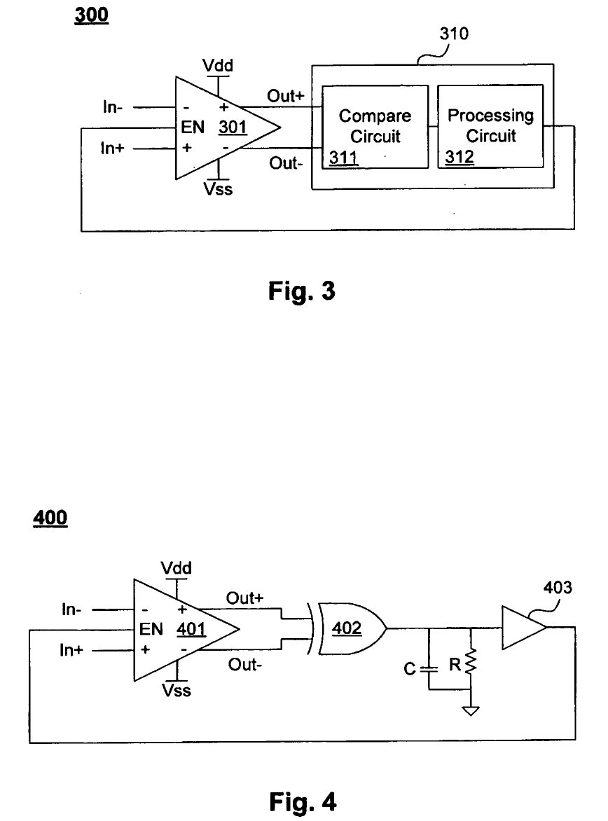

FIG. 3 is an example of a short circuit protection circuit according to another embodiment of the present invention. In this example, complementary short circuit protection circuit 310 includes a comparison circuit 311 and a processing circuit 312. Comparison circuit 311 is coupled to the output terminals of circuit 301. Comparison circuit 311 compares the state of the output terminals and, based on the result, generates a signal to processing circuit 312 indicating whether or not the signals on the output terminals indicate that there is a short circuit. For example, if the output terminals are voltage outputs, then comparison circuit may compare the voltage on “out+” to the voltage on “out−”. Since the circuit is complementary, the voltages should not be the same, but rather, 180 degrees out of phase. Thus, if the voltages are the same, then such a condition indicates that there is a short circuit between “out+” and “out−”. Processing circuit 312 receives a signal from comparison circuit 311 and generates a disable signal necessary to turn off electronic circuit 301.

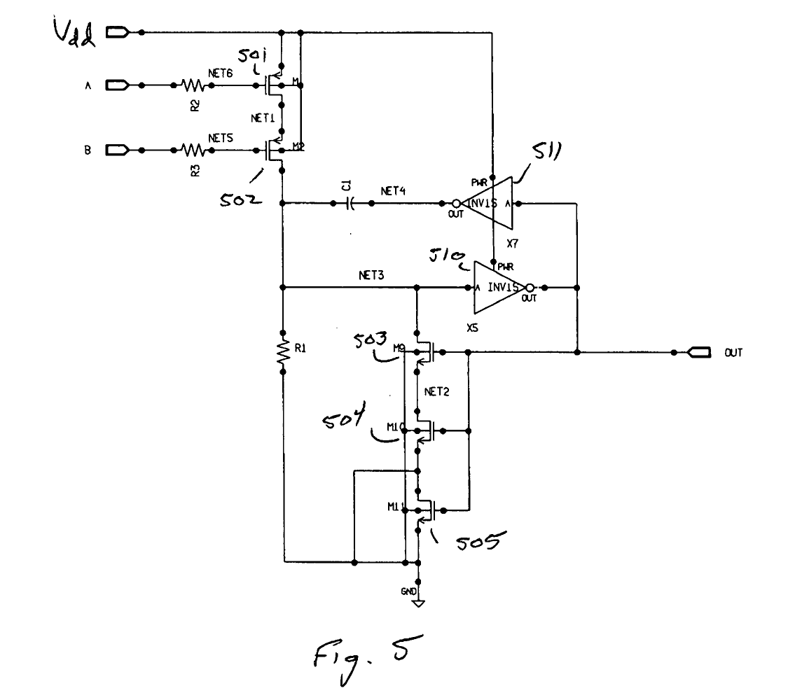

FIG. 4 is an example of a short circuit protection circuit according to another embodiment of the present invention. In this example, comparison is implemented using an exclusive OR circuit 402 (“XOR”), and processing circuit includes a buffer 403 coupled to the output of XOR 402. Furthermore, a resistor R and capacitor C are coupled to ground at the input of the buffer. When the circuit is operating properly, output terminal “out+” is 180 degrees out of phase with output terminal “out−”. This phase difference is detected by examining the voltage difference between the outputs. Thus, the output of the XOR will be logic high when the outputs are different, and the output of the buffer will be logic high. A logic high in this example will be an enable signal at the EN input of circuit 401. Thus, with EN high, the circuit will operate normally. However, in the event of a short circuit, the output terminals “out+” and “out−” are electrically connected together. Thus, both inputs of the XOR will have the same value, and the output of the XOR will transition to logic low. A logic low in this example will be a disable signal. Thus, with EN low, the circuit will turn off. Accordingly, the short circuit protection circuit will detect when the outputs are at the same value and turn off the circuit. In this example, a resistor R and capacitor C are provided between the output of the XOR and the input of the buffer. Capacitor C will act as a low pass filter so that the XOR circuit does not turn off circuit 401 when the output terminals “out+” and “out−” reverse polarity for a short period of time. Additionally, the RC circuit acts as a timing circuit by providing a time constant, so that if the XOR detects an intermittent short circuit between “out+” and “out−” (e.g., if someone unintentionally touches a wire between the outputs), then the short circuit protection circuit will wait a predetermined amount of time after the short is cleared (e.g., as set by the time constant) before changing the disable signal back to an enable signal. The output of the RC circuit may be passed through a buffer 403 to ensure proper signal integrity. Alternatively, buffer 403 may be a Schmitt Trigger buffer with hysteresis.

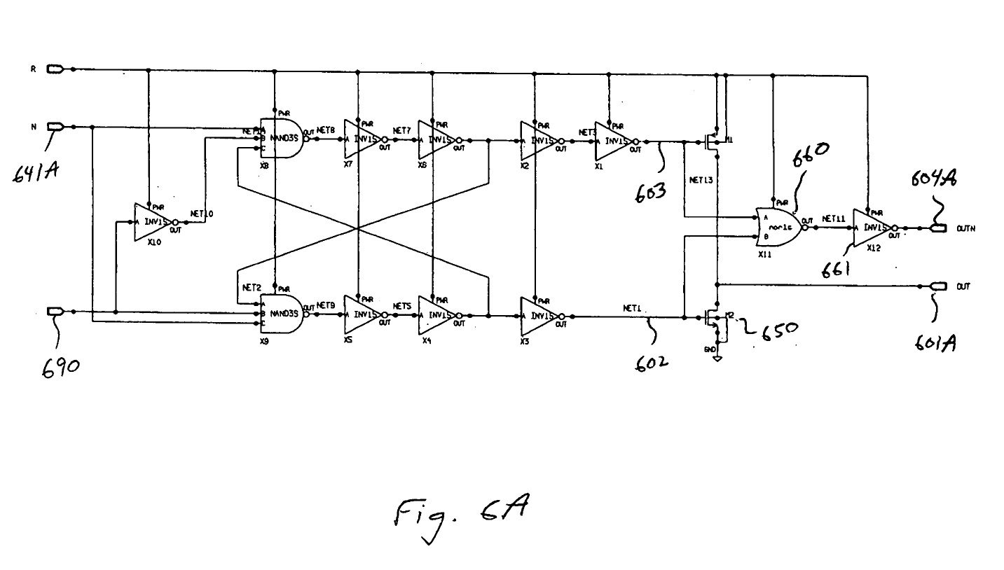

FIG. 5 is another example of a short circuit protection circuit according to one embodiment of the present invention. In FIG. 5, an output terminal of an electronic circuit (not shown) and a complementary node of such circuit are coupled to protection circuit input terminals A and B. These terminals are, in turn, coupled to a NAND gate, which in this case includes transistors 501 and 502 and isolation resistors R2 and R3. During normal operation, the voltages on terminals A and B should be opposite (e.g., A is high and B is low or A is low and B is high). However, if both terminals are shorted together, then the voltages will average out at approximately one-half Vdd, which will turn on both transistors 501 and 502. When transistors 501 and 502 turn on, a current will flow from supply Vdd into series transistors 503-505, which are initially biased “on” by inverter 510 because the input to inverter 510 is discharged to ground by resistor R1. When current flows through transistors 501 and 502, the input to inverter 510 will charge up to about Vdd. This voltage will be stored on capacitor C1. Additionally, inverter 510 will change state and the output of the circuit at “OUT” will go to logic low. This signal is the disable signal, and it may be coupled to the enable input of the electronic circuit to be shut down. When the output of inverter 510 goes low, the output of inverter 511 changes from low to high. This causes the voltage on the other terminal of capacitor C1 to increase to Vdd. Capacitor C1 and resistor R1 implement a timing circuit. After the short circuit is detected and the disable signal generated, the voltage stored on the capacitor will begin to discharge through the resistor. The RC time constant will determine the rate at which the voltage at the input to inverter 510 changes toward ground. After the voltage at the input to inverter 510 has fallen below the inverter's switching point, inverter 510 will change state and reset the disable signal. As a result, the electronic circuit will be re-enabled and turn back on.

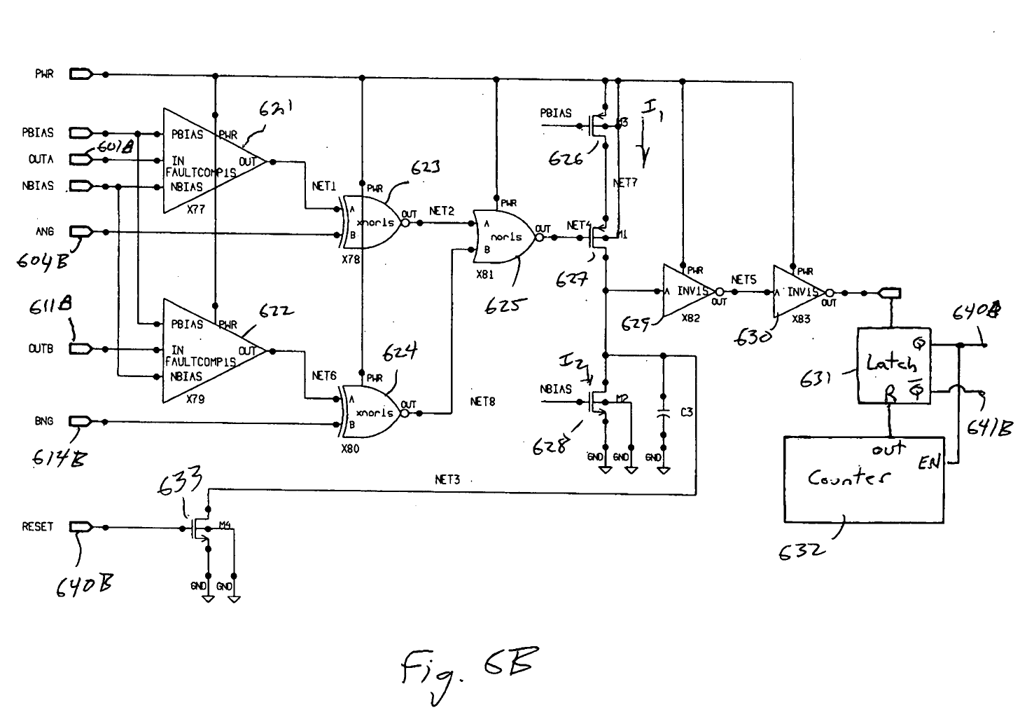

FIGS. 6A and 6B illustrate another example of a short circuit protection circuit according to one embodiment of the present invention. FIG. 6A illustrates an output signal path of a circuit. In one embodiment, an electronic circuit may include two such output signal paths that are complements of each other. Such a circuit would have two circuits of the type shown in FIG. 6A with an input signal being received on node 690 and an output signal being generated on output terminal 601A (“out”). In one embodiment, the input and output signals may be pulse-width modulated signals (e.g., for use in a Class-D Amplifier). FIG. 6B illustrates a short circuit protection circuit for shutting down the output signal path shown in FIG. 6A. Output terminal 601A is coupled to terminal 601B, which is one input of a protection circuit shown in FIG. 6B. Another input to the protection circuit at terminal 604B is coupled to a node having a voltage that has a complementary phase relationship to the voltage on the output terminal 601A under normal operation. In this example, the complementary node is node 602 in FIG. 6A. In this particular example, node 602 is connected to the gate of transistor 650. Since the output node 601A is connected to the drain of transistor 650, node 602 will be complementary to output node 601A because when node 602 is high, the output node 601A is low, and when node 602 is low, output node 601A is high. In this example, a second node 603 is also coupled to the input 604B of the protection circuit. From FIG. 6A it can be seen that nodes 602 and 603 should move together under normal operation. A fault may be detected if the nodes do not move together. Nodes 602 and 603 are coupled through an OR gate comprising NOR gate 660 and inverter 661 to the input node 604A/B of the protection circuit.

Referring to FIG. 6B, the output terminal 601A is coupled to an output signal qualification circuit. An output signal qualification circuit examines the output and determines if a valid output exists or not. In this example, such a circuit is implemented using a window comparator 621. The output of window comparator 621 will transition from low to high if the output terminal 601A/B transitions from low to a high level voltage greater than a low-to-high trigger voltage of the comparator. Similarly, the output of window comparator 621 will transition from high to low if the output terminal 601A/B transitions from high to a low level voltage less than a high-to-low trigger voltage of the comparator. However, if the output terminal is shorted (e.g., to another output terminal) the voltage may not transition properly. For example, if the output terminal 601A is connected to a complementary output terminal, then the voltage may be one-half the supply voltage. The output of the output signal qualification circuit will only transition if the output transitions properly. If the output terminal is shorted, the output signal qualification circuit will not transition. The short circuit protection circuit of FIG. 6B compares the state of internal node 602 (or 603) to the output of the qualification circuit. If the qualification circuit is not complementary to node 602, as it should be under normal operation, then a fault condition may be detected. In this example, and exclusive OR circuit 623 (“XOR”) is used to compare the output of the qualification circuit to node 602 (or 603). A similar qualification circuit comprising window comparator 622 may be used for the other output terminal of the circuit at the end of a similar complementary channel to the one shown in FIG. 6A (not shown), which may be connected to node 611B. The output of comparator 622 may be compared to an internal node in the complementary channel using XOR 624. Thus, both output terminals may be monitored for short circuits by comparing each output terminal to respective nodes that indicate what the voltage on each output terminal should be doing (i.e., a node that is the complement of the output terminal). If the output terminal deviates from its expected state, a short circuit may be detected.

In FIG. 6B, the comparison circuits, including the qualification circuits and XOR circuits for each channel, are coupled to processing circuits for turning off the electronic circuit being monitored if a short circuit is detected. For example, both XOR circuits 623 and 624 are coupled through a NOR gate 625 to turn on transistor 627 and current I1 if a fault is detected. Current I1 charges a capacitor C3, which acts as a low pass filter short as mentioned above, and the voltage on the input of inverter 629 increases. When the input to inverter 629 is logic high, a logic low is generated at the input of inverter 630, which causes the output of inverter 630 to be logic high. This logic high is stored in latch 631 and used turn off the electronic circuit being monitored and activates a timing circuit. Also, the Q output of latch 631 is coupled to turn on transistor 633 and discharge capacitor C3 and the gate of inverter 629, which effectively resets the processing circuit to await the next fault. However, the electronic circuit will not turn back on until the latch is cleared. In this example, when the latch is set high, the Q output at node 640B is used to start a counter 632. The Qbar output node 641B is connected to node 641A in FIG. 6A and used to turn off the circuit in FIG. 6A. Counter 632 will reset latch 631 after a time period. When the latch is reset, the circuit in FIG. 6A will be turned back on and the Q output turns off transistor 633 so another fault can be detected.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A short circuit protection circuit comprising:
a first circuit having a first output terminal, a second complementary output terminal, an enable input terminal, and at least one node, wherein a first voltage on the first output terminal has a complementary phase relationship to a second voltage on the at least one node under normal operation; and
a short circuit protection circuit having a first input terminal coupled to the first output terminal of the first circuit, a second input terminal coupled to the at least one node of the first circuit, and an output terminal coupled to the enable input terminal of the first circuit,
wherein if the first output terminal is electrically connected to the second output terminal, the short circuit protection circuit generates a disable signal to the enable input terminal turning off the first circuit.

2. The short circuit protection circuit of claim 1 wherein the at least one node is connected to the second output terminal.

3. The short circuit protection circuit of claim 1 wherein the at least one node is a node internal to the first circuit.

4. The short circuit protection circuit of claim 1 wherein the short circuit protection circuit comprises a comparison circuit and a processing circuit that processes the output of the comparison circuit and generates said disable signal.

5. The short circuit protection circuit of claim 4 wherein the comparison circuit comprises an exclusive OR circuit.

6. The short circuit protection circuit of claim 4 wherein the processing circuit comprises an RC circuit and an inverter.

7. The short circuit protection circuit of claim 1 wherein the short circuit protection circuit comprises:
a window comparator circuit having a first input coupled to the first output terminal; and
an exclusive OR circuit having a first input coupled to an output of the window comparator circuit and a second input coupled to the at least one node.

8. The short circuit protection circuit of claim 1 wherein the short circuit protection circuit includes a timing circuit, wherein if a short circuit is detected the timing circuit turns off the first circuit for a first time period.

9. A short circuit protection circuit comprising:
a first circuit having a first output terminal, a second complementary output terminal, an enable input terminal, and at least one node, wherein a first voltage on the first output terminal has a complementary phase relationship to a second voltage on the at least one node under normal operation; and
a short circuit protection circuit comprising
a comparison circuit having a first input coupled to the first output terminal of the first circuit, a second input terminal coupled to the at least one node of the first circuit; and
a timing circuit having an input coupled to an output of the comparison circuit and an output coupled to the enable input terminal of the first circuit,
wherein if the first output terminal is electrically connected to the second output terminal, the short circuit protection circuit generates a disable signal to the enable input terminal turning off the first circuit for at least a first time period determined by the timing circuit.

10. The short circuit protection circuit of claim 9 wherein the comparison circuit comprises an exclusive OR gate.

11. The short circuit protection circuit of claim 9 wherein the comparison circuit comprises a window comparator coupled to an exclusive OR gate.

12. The short circuit protection circuit of claim 9 wherein the comparison circuit comprises a NAND gate.

13. The short circuit protection circuit of claim 9 wherein the timing circuit comprises a resistor and capacitor.

14. The short circuit protection circuit of claim 9 wherein the timing circuit comprises a counter.

15. The short circuit protection circuit of claim 9 wherein the timing circuit comprises latch and a counter.

16. A short circuit protection method comprising:
comparing a first voltage on a first output terminal of a first circuit to a second voltage on at least one other node in the circuit having a complementary voltage during normal operation; and
generating at least one disable signal when the first voltage is not complementary to the second voltage, and in accordance therewith, turning off the first circuit.

17. The method of claim 16 further comprising resetting the disable signal after a first time period.

18. The method of claim 16 wherein the at least one node is connected to the second output terminal.

19. The method of claim 16 wherein the at least one node is a node internal to the first circuit.

20. The method of claim 16 further comprising storing a voltage on a capacitor and resetting the disable signal when the voltage on the capacitor discharges through a resistor.
